(19) United States
(12) Patent Application Publication
(10) Pub. No.: US 2006/0007472 A1
(43) Pub. Date: Jan. 12, 2006

(54) Image forming apparatus and image data transfer method

(75) Inventor: Yousuke Takebe, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/883,781

(22) Filed: Jul. 6, 2004

(51) Int. Cl. G06F 15/00

(52) U.S. Cl. 358/1.15

(57) ABSTRACT

An image forming apparatus that forms a multi-color image by combining images of different colors includes: an image data output unit that outputs the image data of each of the different colors through transmission paths allocated for the respective different colors; and a control unit that outputs color images to form the multi-color image to the image data output unit, and notifies the image data output unit which transmission path is to be used to transmit the image data of each of the different colors. When only a designated color among the different colors is used to form an image, the control unit converts the format of the image data of the designated color, and outputs the converted image data to the image data output unit. In accordance with the setting by the control unit, the image data output unit outputs the converted image data of the designated color through the transmission path allocated for the designated color and the transmission path allocated for a color that is not used to form the image.

### BACKGROUND OF THE INVENTION

1. Field of the invention

The present invention generally relates to an image forming apparatus that forms an image using toners of different colors such as C (cyan), M (magenta), Y (yellow), and K (black).

2. Description of the Related Art

A conventional image forming apparatus that forms an image with toners of different colors such as C, M, Y, and K is normally of a single engine type that has only one image write unit that includes a photosensitive drum, a charging device, and an electrostatic image writing device, as shown in FIG. 18. To form an image, such an image forming apparatus of a single engine type repeats an image forming operation the same number of times as the number of colors that are to form the image. By repeating the image forming operation, images of different colors are combined. In recent years, however, there have been an increasing number of image forming apparatuses of a tandem type that has an independent image write unit for each color to form a multi-color image at a high speed.

In such a tandem-type image forming apparatus, image data that are read by a scanner or an externally connected personal computer (PC) are transmitted to the image data write unit through the transmission path allocated to each color, thereby forming an image at a high speed.

Japanese Patent Application Publication No. 11-203062 discloses a technique of increasing the printing speed by simultaneously performing two operations. In accordance with the invention disclosed in this publication, the process of receiving data from a host computer and a process of transmitting the received data to the printer engine are simultaneously carried out so as to increase the printing speed.

Japanese Patent Application Publication No. 8-102810 discloses a technique of switching methods of transmitting image signals to another printer depending on the printing mode, so as to complete two different operations at the same time. More specifically, when a color converting process is to be carried out by a color converting unit, RGB image signals are collectively transmitted to another printer via a video interface. When a free color paint process or a free color process is to be performed, MCYK image signals that are temporarily stored in an image memory are transmitted to another printer in the plane order via a video interface.

In a full-color printing mode, the image data of each color are transmitted through the transmission paths of all the colors. In a limited color printing mode such as a black-and-white printing mode, however, the image data of the designated color are transmitted through the transmission path allocated for the designated color, and any other transmission path is not used.

Japanese Patent Application Publication No. 11-203062 discloses the technique for increasing the printing speed by performing a data receiving operation and a received data transmitting operation at the same time, as mentioned earlier. However, this technique does not involve the use of transmission paths depending on the printing mode either.

The technique disclosed in Japanese Patent Application Publication No. 8-102810 simply relates to the simultaneous execution of two different operations, but does not involve the use of transmission paths depending on the printing mode.

As the black-and-white printing mode in a multi-color color image forming apparatus is selected more frequently, a higher processing speed is required for the black-and-white printing mode than for any multi-color printing mode. Therefore, in the black-and-white printing mode, it is necessary to transmit image data at higher frequencies than in a multi-color mode. Even in the black-and-white printing mode, high image quality data are required to transmit a photographic image. In doing so, the data amount also increases with the image quality, and therefore, the transmission frequencies need to be further increased to achieve higher productivity.

However, the transmission frequencies cannot be increased without any restriction, because factors such as the circuit capacity and the transmission distance affect the transmission frequencies. Also, as the transmission frequencies increase, it becomes more difficult to maintain the waveform quality of signals to be transmitted. Furthermore, there is a probability of an increase in radiation noise.

### SUMMARY OF THE INVENTION

It is therefore an object of the present invention to provide an image forming apparatus and an image data transmission method in which the above disadvantages are eliminated.

The above object of the present invention is achieved by an image forming apparatus that forms a multi-color image by combining images of different colors, including: an image data output unit that outputs the image data of each of the different colors through transmission paths allocated for the respective different colors; and a control unit that outputs color images to form the multi-color image to the image data output unit, and notifies the image data output unit which transmission path is to be used to transmit the image data of each of the different colors. When only a designated color among the different colors is used to form an image, the control unit converts the format of the image data of the designated color, and outputs the converted image data to the image data output unit. In accordance with a setting by the control unit, the image data output unit outputs the converted image data of the designated color through the transmission path allocated for the designated color and the transmission path allocated for a color that is not used to form the image.

The above object of the present invention is also achieved by an image forming apparatus that forms a multi-color image by combining images of different colors, including: an image data output unit that outputs the image data of each of the different colors through transmission paths allocated for the respective different colors; and a control unit that outputs color images to form the multi-color image to the image data output unit, and notifies the image data output unit which transmission path is to be used to send the image data of each of the different colors. The image data output unit outputs color image data having a converted format through the transmission path allocated for the color and a transmission path allocated for a color that is not used.

The above object of the present invention is also achieved by an image data transmission method that uses transmission paths at least either to send image data within an image forming apparatus or to send image data between the image forming apparatus and an external device, with the transmission paths being provided for different colors to form an image. This method includes the steps of: when an image is formed only with a designated color among the different colors, converting the format of the image data of the designated color; and transmitting the converted image data of the designated color through the transmission path allocated for the designated color and a transmission path allocated for a color that is not used to form the image.

The above object of the present invention is also achieved by an image data transmission method that uses transmission paths at least either to transmit image data within an image forming apparatus or to transmit image data between the image forming apparatus and an external device, with the transmission paths being provided for different colors to form an image. This method includes the step of, when an image is formed only with a designated color among the different colors, transmitting the image data of the designated color through the transmission path allocated for the designated color and a transmission path allocated for a color that is not used to form the image.

### BRIEF DESCRIPTION OF THE DRAWINGS

Other objects, features and advantages of the present invention will become more apparent from the following detailed description when read in conjunction with the accompanying drawings, in which:

FIG. 1 illustrates the structure of the image write units of an image forming apparatus in accordance with the present invention;

FIG. 2 illustrates the structures of the system control unit and the engine control unit;

FIG. 3 illustrates the transmission paths between the system control unit and the engine control unit;

FIG. 4 illustrates signals transmitted between the system control unit and the engine control unit;

FIG. 5 illustrates an example of an image format converting operation;

FIG. 6 illustrates the operation of the image data transmitting unit in the system control unit;

FIG. 7 illustrates the structure of the engine control unit;

FIG. 8 illustrates the operation of the engine control unit in a black single-color printing mode;

FIG. 9 illustrates the structure of the combining unit;

FIG. 10 illustrates signals to be inputted into the combining unit and signals to be outputted from the combining unit;

FIG. 11 illustrates the operation of the image data transmitting unit in the system control unit;

FIG. 12 illustrates the operation of the image data transmitting unit in the system control unit;

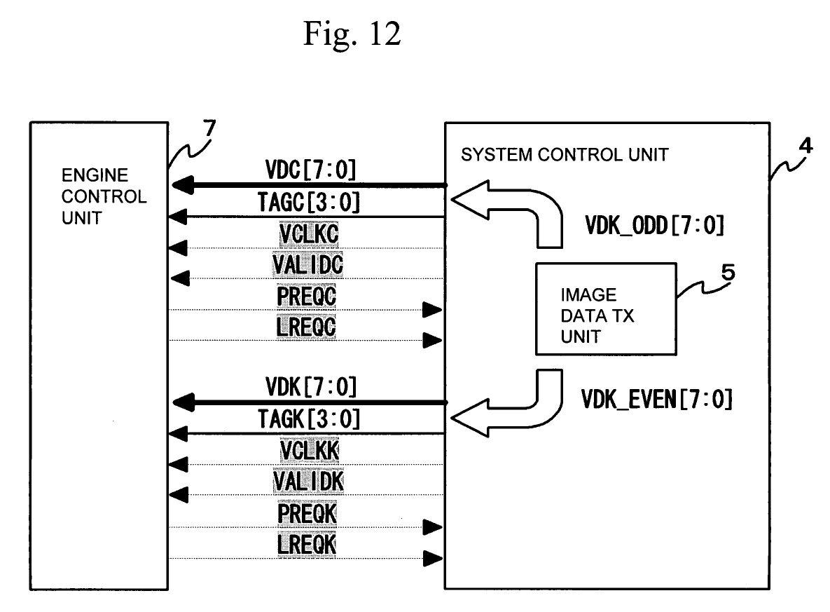

FIG. 13 illustrates the operation of the engine control unit in the black single-color printing mode;

FIG. 14 illustrates the structure of the combining unit;

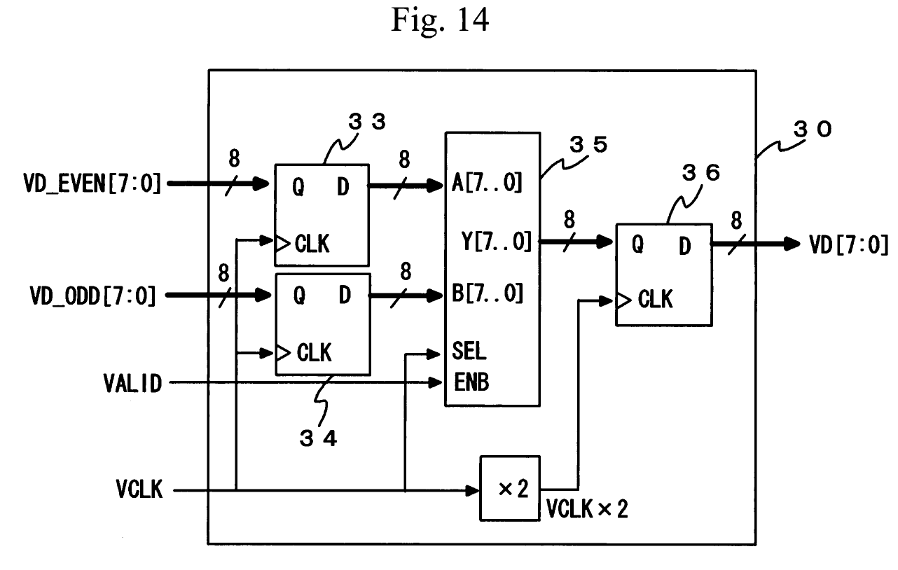

FIG. 15 illustrates signals to be inputted into the combining unit and signals to be outputted from the combining unit;

FIG. 16 illustrates the operation of the image data transmitting unit in the system control unit;

FIG. 17 illustrates the operation of the engine control unit in a two-color printing mode; and

FIG. 18 illustrates the structure of an image write unit of a single engine type.

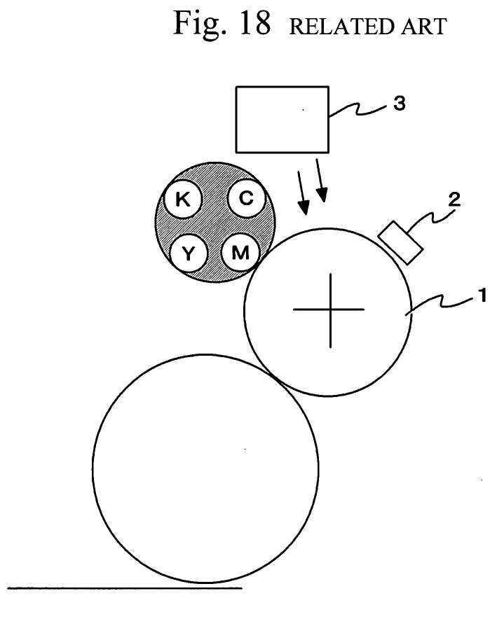

### DESCRIPTION OF THE PREFERRED EMBODIMENTS

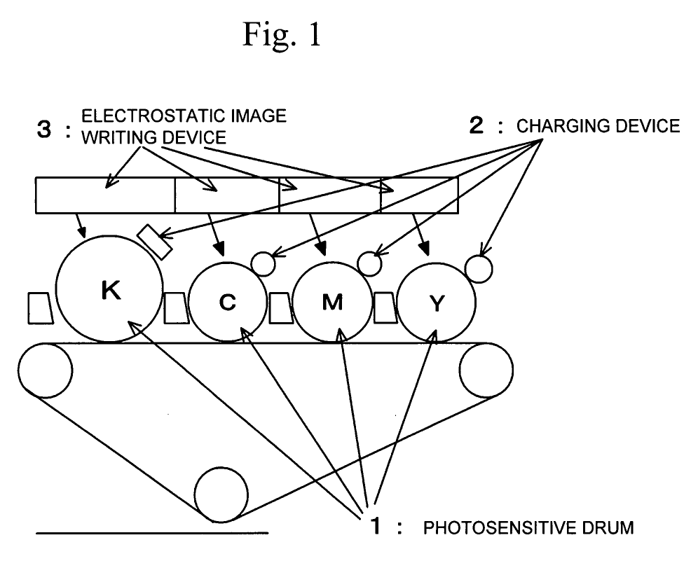

FIG. 1 illustrates the structure of an image forming apparatus in accordance with the present invention.

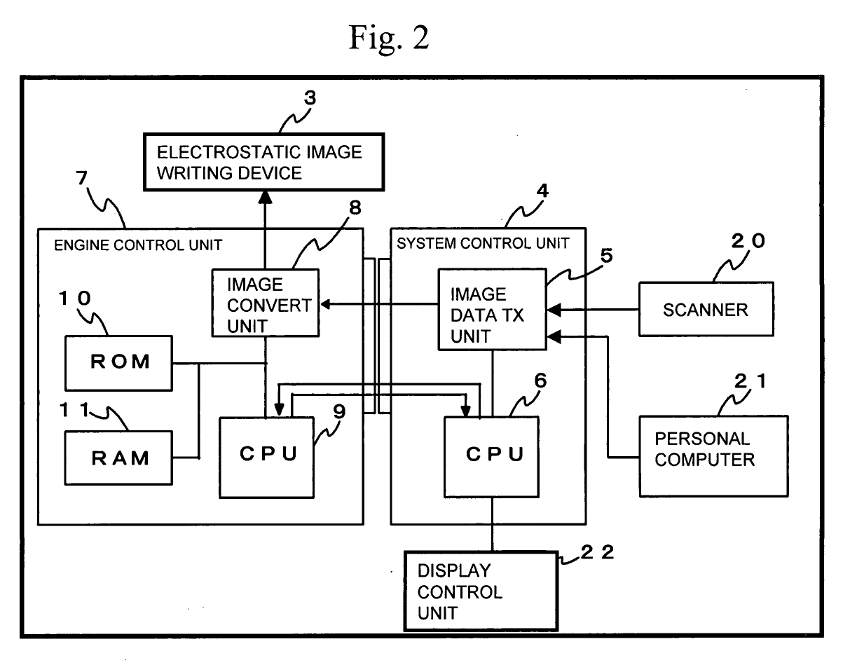

As shown in FIG. 1, the image forming apparatus of this embodiment includes photosensitive drums 1, charging devices 2 that charge the photosensitive drums 1, and electrostatic image writing devices 3 that write electrostatic images on the charged photosensitive drums 1 with laser beams. Each set of those components is allocated for each corresponding one of colors that are used to form images. As shown in FIG. 2, the image forming apparatus also includes a system control unit 4 that controls the entire image forming apparatus, and an engine control unit 7 that controls a printer engine.

As shown in FIG. 2, the system control unit 4 includes a CPU 6 and an image data transmitting unit 5. The CPU 6 receives data read by a scanner 20 and data produced by a personal computer 21 (hereinafter referred to simply as the PC 21), and converts the data into image data that are made up of dots. The CPU 6 sends control information to a CPU 9 of the engine control unit 7 through serial communication. The control information includes image forming mode setting information that is set by an operator (including information to be used to set the transmission path for transmitting image data), and instruction information to be used to start an image forming operation. The image data transmitting unit 5 receives image data processed by the CPU 6, and transmits the image data to an image converting unit 8 of the engine control unit 7 through the transmission path allocated for a color that is set by the CPU 6.

Also, the CPU 6 of the system control unit 4 is connected to the scanner 20, the PC 21, an operation display unit 22, or the like, as shown in FIG. 2. The CPU 6 receives data read by the scanner 20, or data produced by the PC 21. The CPU 6 also forms an image in accordance with the image forming mode set through the operation display unit 22. As an instruction from an operator can be accepted, an image forming operation that meets the requirements of each operation can be performed.

The engine control unit 7 includes the image converting unit 8, the CPU 9, a ROM 10, and a RAM 11, as shown in FIG. 2. The CPU 9 controls the printer engine in accordance with a control program written in the ROM 10, with the RAM 11 being used as a work area. The image converting unit 8 receives and processes the image data transmitted from the image data transmitting unit 5, and outputs the image data to the electrostatic image writing devices 3 in accordance with a transmission instruction issued from the CPU 9.

The image forming apparatus of this embodiment is a tandem-type multi-color image forming apparatus that is equipped with an image writing unit for each of colors that are used to form an image. In this image forming apparatus, a transmission path is also provided for each color.

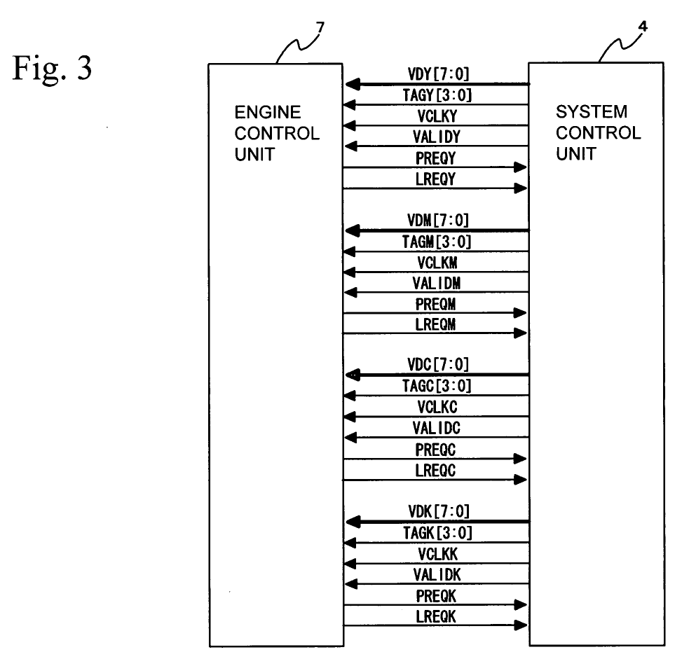

Referring now to FIG. 3, data transmission between the system control unit 4 and the engine control unit 7 is described.

As shown in FIG. 3, the transmission paths extending from the system control unit 4 to the engine control unit 7 are allocated for Y, M, C, and K. The data of each of the colors Y, M, C, and K to be transmitted from the system control unit 4 to the engine control unit 7 include 8-bit video data (VD) (image data), 4-bit tag data (TAG), a transmission clock signal (VCLK), and a signal (VALID) that indicates the valid range of the video data (image data). The data of each of the colors Y, M, C, and K to be transmitted from the engine control unit 7 to the system control unit 4 include a page request signal (PREQ) that indicates the page end (the valid range), and a line request signal (LREQ) that indicates the end (the valid range) of each line (in the main scanning direction).

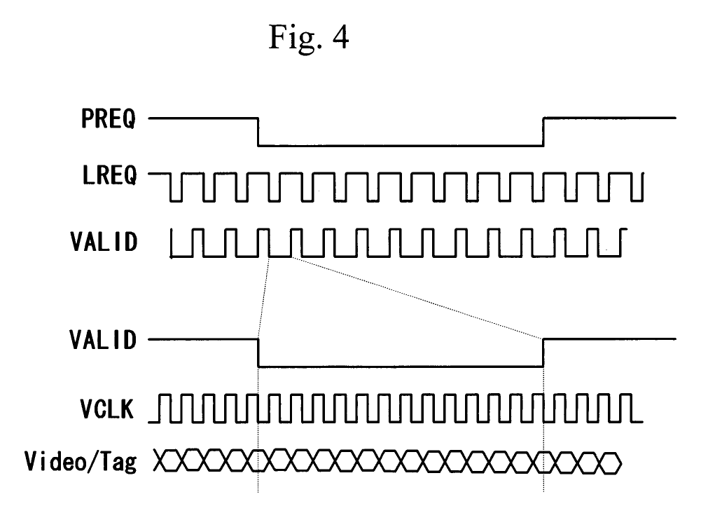

Referring now to FIG. 4, the timing of data transmission from the system control unit 4 to the engine control unit 7 is described.

The system control unit 4 outputs the video data (VD), the tag data (TAG), and the signal (VALID) indicating the valid period, as well as the transmission clock (VCLK), during the period of time in which the page request signal (PREQ) and the line request signal (LREQ) outputted from the engine control unit 7 become valid in response to a data transmission request outputted from the system control unit 4 to the engine control unit 7. In this manner, image data are transmitted from the system control unit 4 to the engine control unit 7.

In the tandem-type multi-color image forming apparatus that is equipped with an image writing unit for each color, the transmission paths for all the colors are used to transmit image data in a full-color printing mode, but the transmission paths for the other colors than the subject color are not used in a single-color printing mode such as a black single-color printing mode.

This embodiment takes advantage of this aspect of the apparatus. In a case where a printing operation does not involve all the colors available in the image forming apparatus, for example, the format of the image data of each color to be used in the printing operation is converted so as to increase the data amount of the image data of the color. In this case, the image data transmission is performed using the transmission paths allocated for the colors to be used in the printing operation as well as the transmission paths allocated for the colors not to be used. In this manner, the image quality of each color used in the printing operation can be improved.

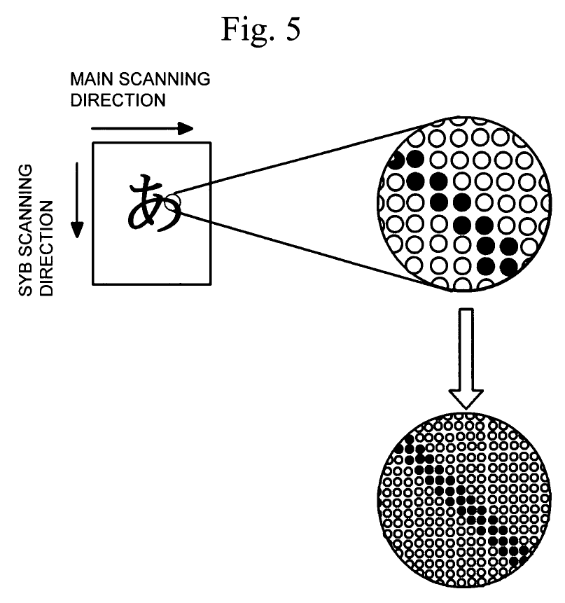

The methods of converting the image data format to increase image quality are not limited to specific techniques, but include a method of increasing the resolution (DPI (Dot Per Inch)) of each image and a method of increasing the number of bits representing one pixel, as shown in FIG. 5.

Next, the structures and operations of the system control unit 4 and the engine control unit 7 are described in greater detail. In the example case described below, the image forming apparatus is set to the black single-color printing mode by an input through the operation display unit 22 of the image forming apparatus or an input through the PC 21.

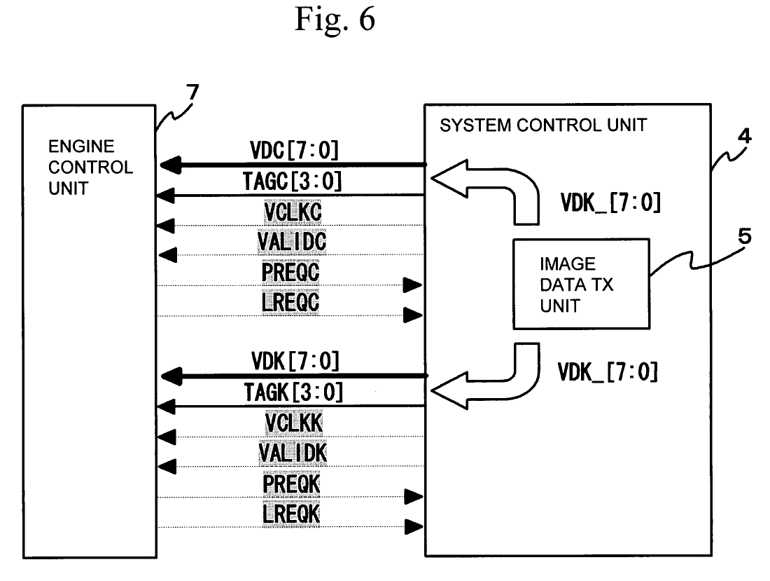

The system control unit 4, from which image data are transmitted, has the image data transmitting unit 5 to divide the increased amount of data into two and to output each portion of the divided data to each corresponding transmission path, as shown in FIG. 6.

The conversion process to increase the data amount of image data is performed by the CPU 6 of the system control 4 shown in FIG. 2, and the converted image data are outputted to the image data transmitting unit 5. The image data transmitting unit 5 then divides the converted image data into two. The dividing process is not limited to a specific method, but image data may be divided into a group of even-number pixels and a group of odd-number pixels in terms of the location in the main scanning direction. The image data transmitting unit 5 then outputs two divided portions of image data, using the transmission path allocated for cyan (C) image data as well as the transmission path allocated for black (K) image data. The cyan transmission path as well as the black transmission path is used, because the cyan (C) transmission path is physically the closest to the black transmission path, which is normally used for black single-color printing operations. As the transmission path of the color that is physically the closest among the transmission arrangement in the apparatus, the amount of data skew can be reduced. In this manner, the image data are transmitted through the transmission path allocated for the designated color and the transmission path that is physically closest to the transmission path allocated for the designated color. Accordingly, the difference in signal transmission time between the transmission paths can be reduced, and there is no need to employ a device to transmit the image data through two or more transmission paths.

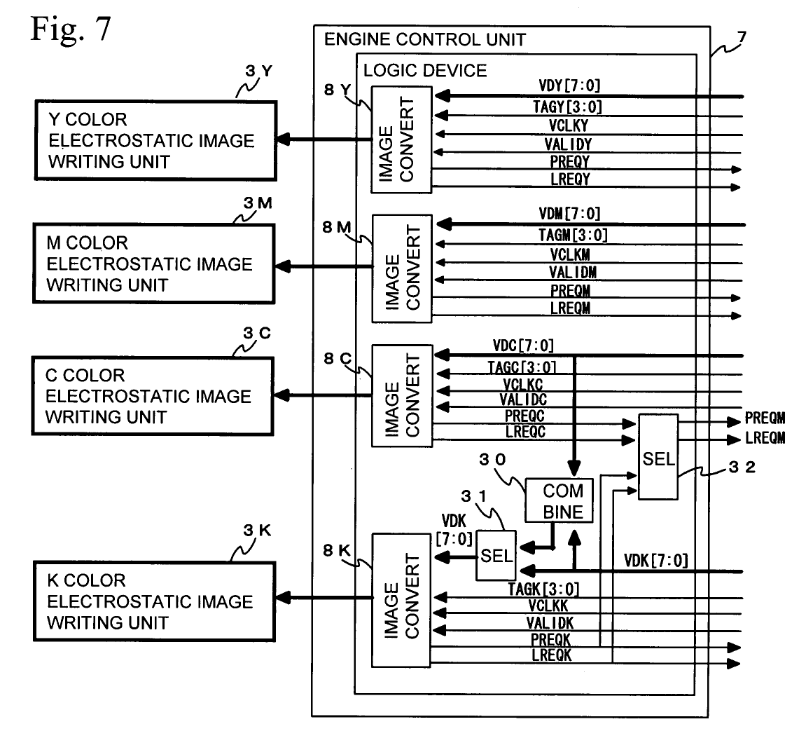

Referring now to FIG. 7, the structure of the engine control unit 7 is described in detail.

As shown in FIG. 7, the engine control unit 7 that receives data transmitted from the system control unit 4 includes a combining unit 30 and selecting units 31 and 32. The combining unit 30 combines the image data received through the transmission path for black (K) with the image data received through the transmission path for cyan (C). The selecting unit 31 selectively outputs either the output of the combining unit 30 or the image data received through the transmission path for black (K). The selecting unit 32 selectively outputs either the page request signal and the line request signal transmitted through the black (K) transmission path or the page request signal and the line request signal transmitted through the cyan (C) transmission path.

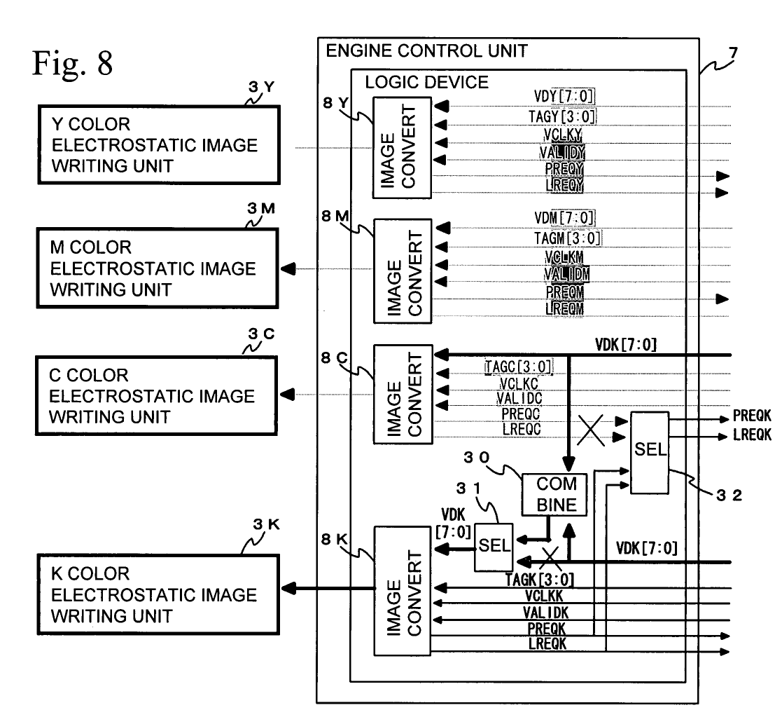

When the black single-mode printing mode is selected, the cyan (C) transmission path serves as another black (K) transmission path. Therefore, the selecting unit 32 of the engine control unit 7 selects the page request signal and the line request signal outputted from the black (K) image converting unit 8K, instead of the page request signal and the line request signal outputted from the cyan (C) image converting unit 8C, and outputs the selected signals to the transmission path for cyan (C), as shown in FIG. 8.

Receiving the page request signal and the line request signal for black (K) through the transmission path for black (K) and the transmission path for cyan (C), the image data transmitting unit 5 of the system control unit 4 outputs the image data of black (K) through the transmission path for black (K) and the transmission path for cyan (C). The combining unit 30 combines the black (K) image data transmitted through the transmission path for black (K) and the transmission path for cyan (C), and outputs the composite black (K) image data. The selecting unit 31 selects the output of the combining unit 30, as the black single-color printing mode is selected, as shown in FIG. 8.

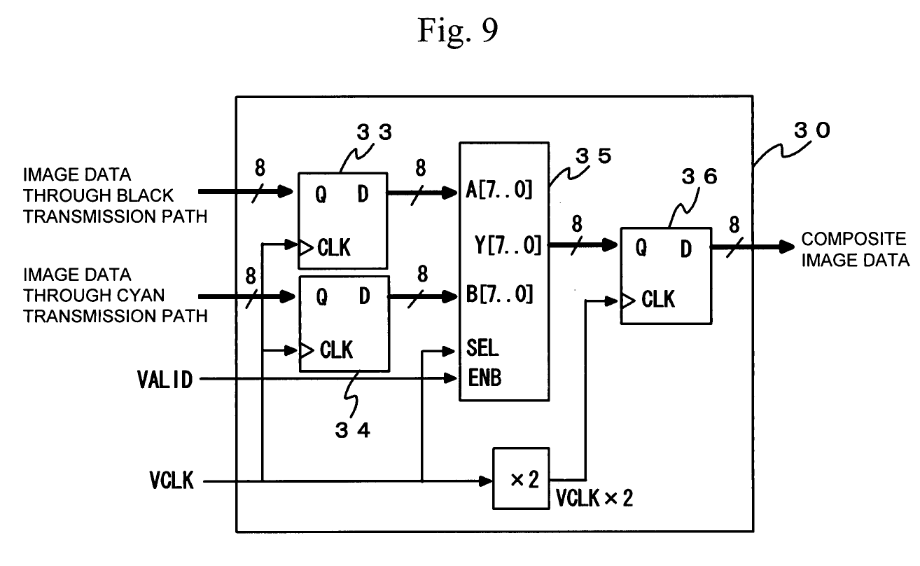

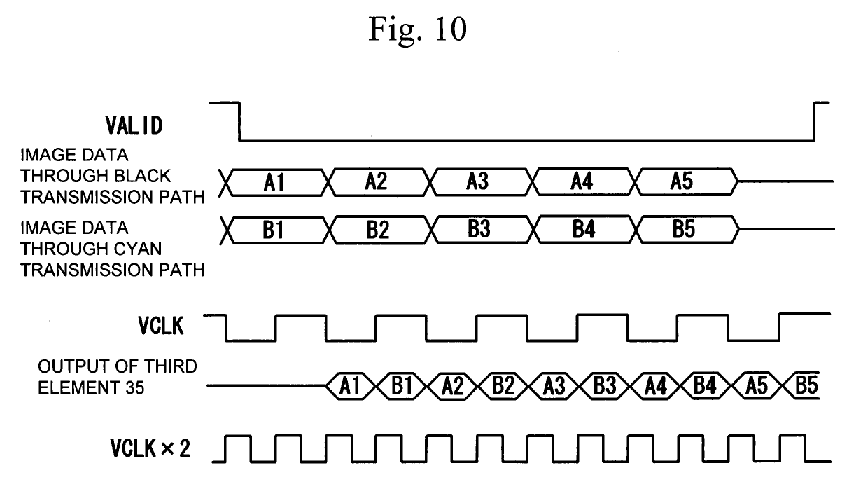

Referring now to FIGS. 9 and 10, the structure and operation of the combining unit 30 are described in detail. As shown in FIG. 9, the combining unit 30 includes a first element 33, a second element 34, a third element 35, and a fourth element 36. The first element 33 inputs the image data transmitted through the transmission path for black (K) and the transmission clock (VCLK). The second element 34 inputs the image data transmitted through the transmission path for cyan (C) and the transmission clock (VCLK). The third element 35 inputs the outputs of the first element 33 and the second element 34, the VALID signal indicating the valid range of the data, and the transmission clock (VCLK). The fourth element 36 inputs the output of the third element 35 and a clock generated by doubling the frequency of the transmission clock (VCLK), and outputs the composite signal of the image data transmitted through the black (K) transmission path and the image data transmitted through the cyan (C) transmission path.

The third element 35 outputs data in synchronization with rising and dropping of the transmission clock (VCLK). Accordingly, the third element 35 outputs the composite data of the image data transmitted through the black (K) transmission path and the image data transmitted through the cyan (C) transmission path to the fourth element 35, as shown in FIG. 10. The output data are then read out from the fourth element 36 with the clock generated by doubling the frequency of the transmission clock (VCLK).

As described above, in a case where the printing operation does not involve all the colors available in the image forming apparatus, the format of the image data of the color designated to be used in the printing operation is converted, and the image data are transmitted through the transmission path allocated for the designated color and the transmission path allocated for a color that is not to be used in the printing operation. In this manner, the image quality of the color used in the printing operation can be improved. Also, image data can be transmitted through different transmission paths with the same control signals, so that the image data can be synchronously transmitted.

If priority is put on the printing speed rather than the image quality in accordance with an instruction set through the operation display unit 22 of the image forming apparatus, the CPU 6 of the system control unit 4 does not convert the data format, and transmits the image data straight through two or more transmission paths.

Next, a second embodiment of the present invention is described.

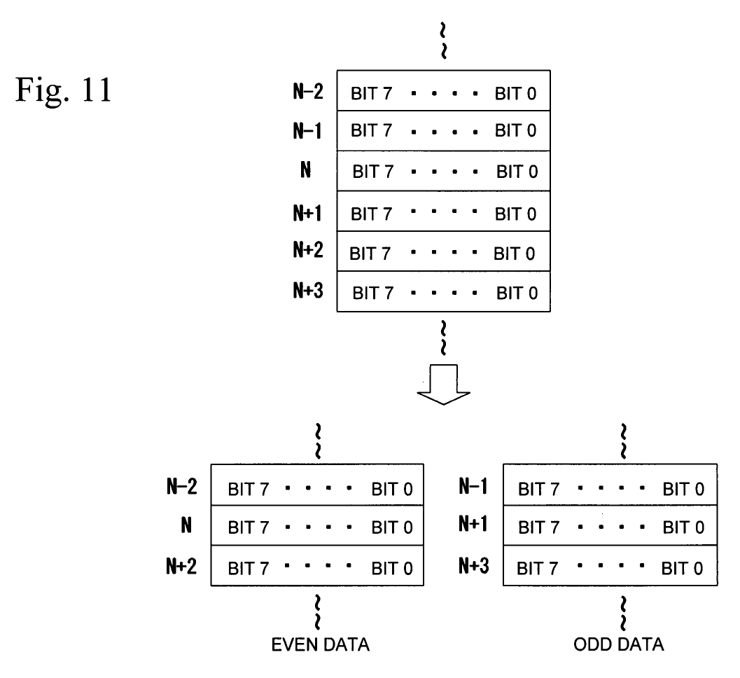

In the first embodiment, high-quality image data with an increased data amount are transmitted to the engine control unit 7 when the black single-color printing mode is selected. In this embodiment, on the other hand, when the black single-color printing mode is selected, the format of the black (K) image data read by the scanner 20 or inputted through the PC 21 is not converted, and the black (K) image data are divided into two (EVEN data and ODD data shown in FIG. 11) and are transmitted through two different transmission paths. This embodiment is effective in a case where the image data transmission speed is increased so as to increase the printing speed.

Where the black single-color printing mode is selected, the image data transmitting unit 5 of this embodiment divides image data inputted from the CPU 6 into even-number (EVEN) data and odd-number (ODD) data. The even number data are image data representing the pixels of even numbers in terms of the pixel location in the main scanning direction, and the odd-number data are image data representing the pixels of odd number in terms of the pixel location in the main scanning direction. The two groups of divided data are outputted to the black (K) transmission path and the cyan (C) transmission path.

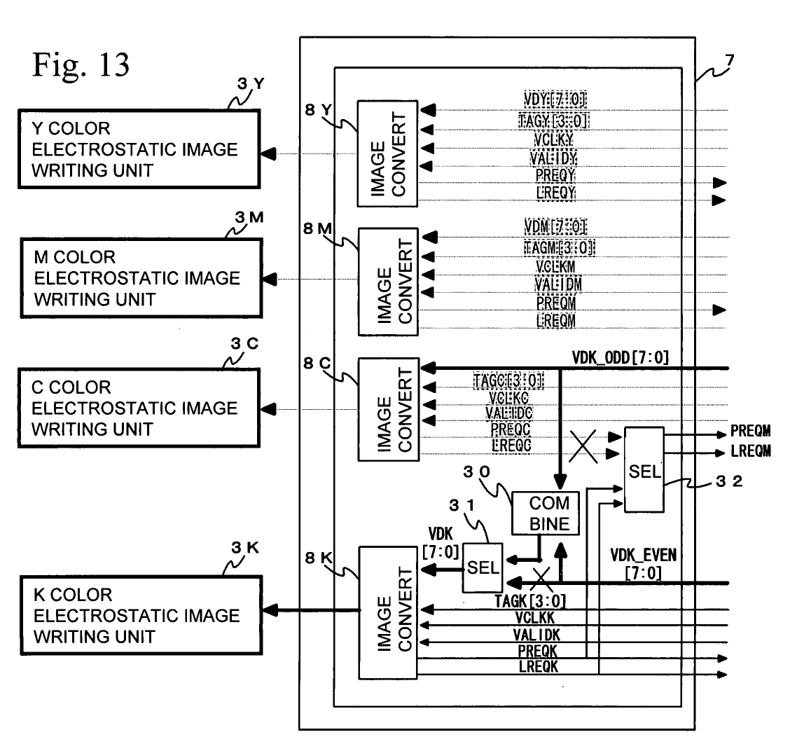

In the black single-color printing mode, the cyan (C) transmission path serves as a black (K) transmission path. Therefore, the selecting unit 32 of the engine control unit 7 shown in FIG. 13 selects the page request signal and the line request signal outputted from the black (K) image converting unit 8K, instead of the page request signal and the line request signal outputted from the cyan (C) image converting unit 8C, and outputs the selected signals to the cyan (C) transmission path. The combining unit 30 combines the black (K) image data transmitted through the black (K) transmission path and the cyan (C) transmission path, and outputs the composite data. The selecting unit 31 selects the output of the combining unit 30 in the black single-color printing mode.

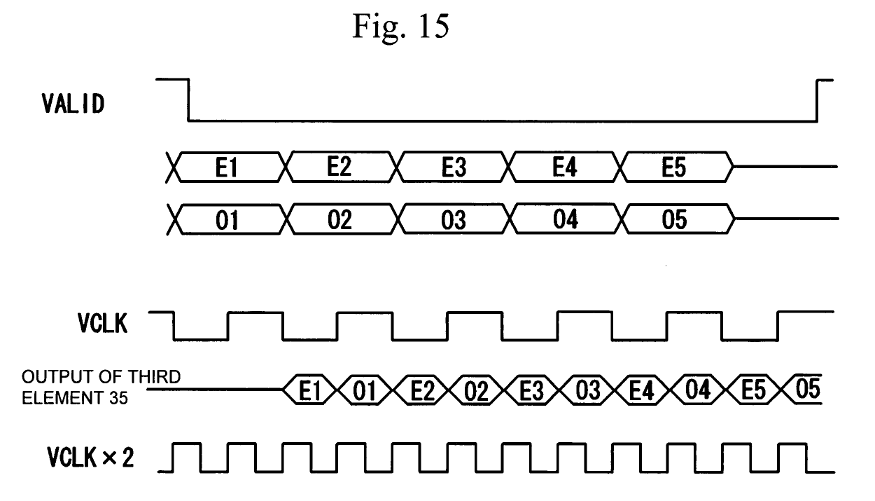

The structure of the combining unit 30 of this embodiment is the same as that of the first embodiment, and therefore, detailed explanation of it is omitted herein. The even-number (EVEN) data outputted from the first element 33 and the odd-number (ODD) data outputted from the second element 34 are inputted into the third element 35, and are then outputted to the fourth element 36 in synchronization with the rising and dropping of the transmission clock (VCLK). In this manner, the composite data shown in FIG. 15 are outputted from the fourth element 36.

As described above, in the black single-color printing mode, the image data are divided by the image data transmitting unit 5 of the system control unit 4, and are transmitted through two transmission paths (the black transmission path and the cyan transmission path). In the engine control unit 7 on the receiving end, the combining unit 30 combines the data transmitted through the two transmission paths and outputs the composite data to the black (K) electrostatic image writing device 3 for printing. In this manner, image data can be transmitted to the printer engine at a higher speed than in a case where image data are transmitted through one transmission path. Thus, the entire printing operation can be speeded up.

If the amount of image data to be used in printing is not very large in the black single-color printing mode, the image data may be transmitted only through the transmission path for the color to be used in the printing. The CPU 6 of the system control unit 4 measures the amount of inputted image data. If the data amount is small enough to be transmitted at a reasonably high transmission speed without the use of two or more transmission paths, the CPU 6 performs control so as not to use two or more transmission paths. By doing so, the power consumption of the image forming apparatus can be reduced.

Next, a third embodiment of the present invention is described.

The above described operations of the first and second embodiments involve the black single-color printing mode. This embodiment, however, involves a case where a multi-color printing mode is selected to use two or more of the colors that are available in the image forming apparatus. In this case, the image data of the colors to be used in the image formation are also transmitted through the transmission paths allocated for the colors and transmission paths allocated for colors that are not used in the image formation. In this manner, the transmission time of the image data to the printer engine can be shortened, and the image forming time and the printing time are also shortened.

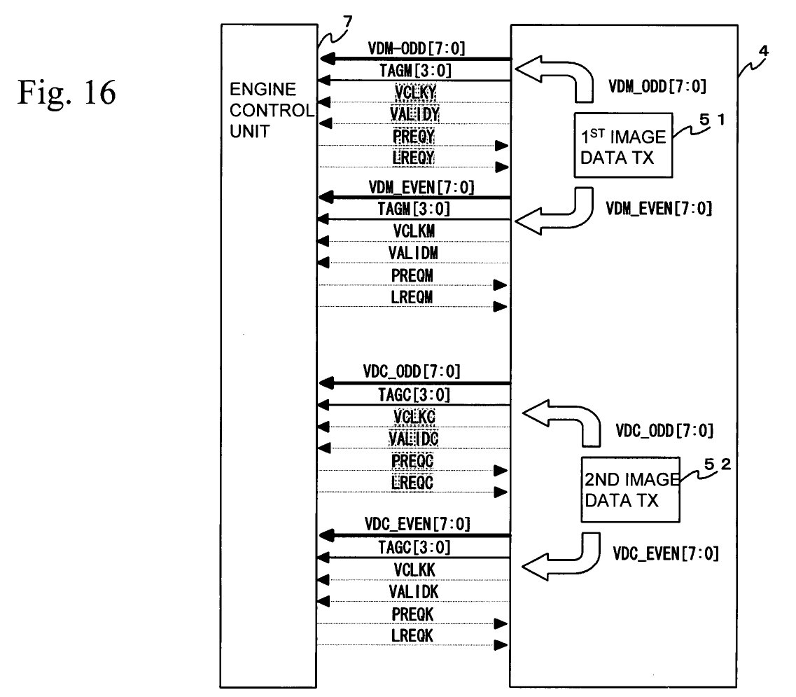

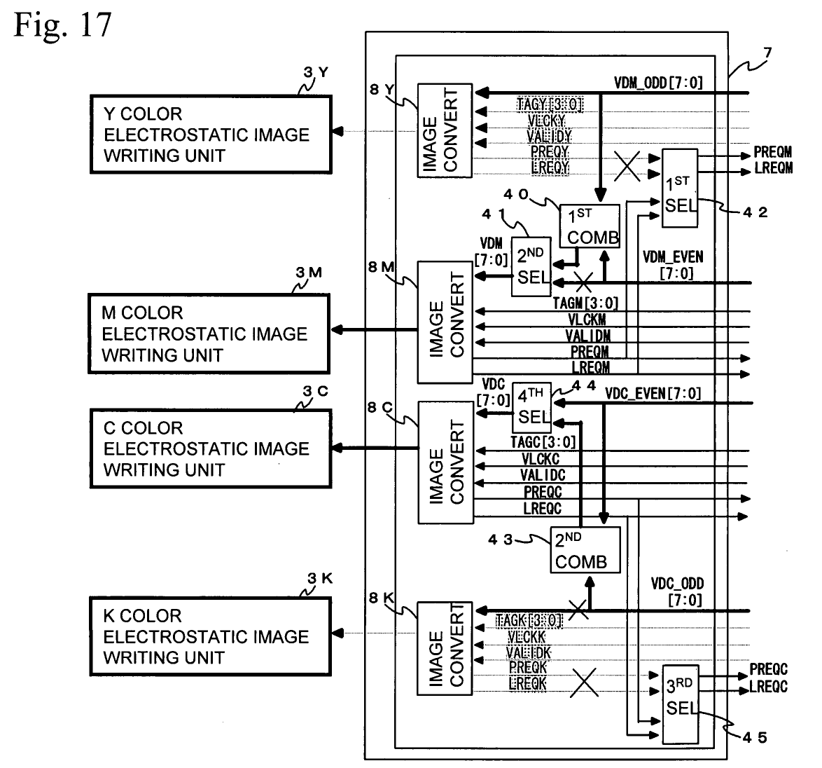

Referring now to FIGS. 16 and 17, the structure and operation of this embodiment are described in detail. In the example case described below, an image is to be formed with magenta (M) and cyan (C), but the present invention is not limited to this combination of colors.

Referring to FIG. 16, the structure of the system control unit 4 of this embodiment is described. As shown in FIG. 16, the system control unit 4 of this embodiment includes a first image data transmitting unit 51 and a second image data transmitting unit 52. The first image data transmitting unit 51 divides the data of magenta (M) transmitted from the CPU 6 shown in FIG. 2 into even-number (EVEN) data and odd-number (ODD) data. The second image data transmitting unit 52 divides the data of cyan (C) into even-number (EVEN) data and odd-number (ODD) data. The first image data transmitting unit 51 outputs the even-number (EVEN) data and the odd-number (ODD) data of magenta (M) to the transmission path allocated for magenta (M) and the transmission path allocated for yellow (Y). The second image data transmitting unit 52 outputs the even-number (EVEN) data and the odd-number (ODD) data of cyan (C) to the transmission path allocated for black (K) and the transmission path allocated for cyan (C).

Referring now to FIG. 17, the structure of the engine control unit 7 of this embodiment is described.

As shown in FIG. 17, the engine control unit 7, which receives data transmitted from the system control unit 4, includes a first combining unit 40, a second selecting unit 41, and a first selecting unit 42. The first combining unit 40 combines the image data received through the magenta (M) transmission path and the image data received through the yellow (Y) transmission path. The second selecting unit 41 selectively outputs either the output of the first combining unit 40 or the image data received through the magenta (M) transmission path. The first selecting unit 42 selectively outputs either the page request signal and the line request signal received through the magenta (M) transmission path or the page request signal and the line request signal received through the yellow (Y) transmission path.

The engine control unit 7 also includes a second combining unit 43, a third selecting unit 45, and a fourth selecting unit 44. The second combining unit 43 combines the image data received through the cyan (C) transmission path and the image data received through the black (K) transmission path. The fourth selecting unit 44 selectively outputs either the output of the second combining unit 43 or the image data received through the cyan (C) transmission path. The third selecting unit 45 selectively outputs either the page request signal and the line request signal received through the cyan (C) transmission path or the page request signal and the line request signal received through the black (K) transmission path.

Where the two-color printing mode of magenta (M) and cyan (C) is selected, the transmission path allocated for yellow (Y) serves as a transmission path for magenta (M). Therefore, the first selecting unit 42 of the engine control unit 7 selects the page request signal and the line request signal outputted from the magenta (M) image converting unit 8M, instead of the page request signal and the line request signal outputted from the yellow (Y) image converting unit 8Y, and then outputs the selected signals to the transmission path for yellow (Y).

Receiving the page request signal and the line request signal for magenta (M) through the magenta (M) transmission path and the yellow (Y) transmission path, the first image data transmitting unit 51 of the system control unit 4 outputs the magenta (M) image data to the magenta (M) transmission path and the yellow (Y) transmission path. The first combining unit 40 combines the image data transmitted through the magenta (M) transmission path and the image data transmitted through the yellow (Y) transmission path, and then outputs the composite data.

Meanwhile, the transmission path for black (K) serves as a transmission path for cyan (C). Therefore, the third selecting unit 45 of the engine control unit 7 selects the page request signal and the line request signal outputted from the cyan (C) image converting unit 8C, instead of the page request signal and the line request signal outputted from the black (K) image converting unit 8K, and then outputs the selected signals to the black (K) transmission path.

Receiving the page request signal and the line request signal through the cyan (C) transmission path and the black (K) transmission path, the second image data transmitting unit 52 of the system control unit 4 outputs the image data to the cyan (C) transmission path and the black (K) transmission path. The second combining unit 43 combines the image data transmitted through the cyan (C) transmission path and the image data transmitted through the black (K) transmission path, and then outputs the composite data.

As described above, the image data of colors to be used in image formation are transmitted through the transmission paths allocated for the designated colors and the transmission paths allocated for other colors that are not used in the image formation in this embodiment. In this manner, the transmission time of image data to the printer engine can be shortened, and the printing time can be shorted accordingly.

In this embodiment, the image data of two colors are transmitted as even-number data and odd-number data through different transmission paths. However, the format of the image data of two or more colors may be converted to improve the image quality, and the image data may be transmitted through the transmission paths allocated for the colors. For example, in the case where magenta (M) and cyan (C) are selected as the colors to be used in image formation as in the third embodiment, the format of the image data is first converted by the CPU 6. The converted magenta (M) image data are then transmitted through the magenta (M) transmission path and the yellow (Y) transmission path, and the converted cyan (C) image data are transmitted through the cyan (C) transmission path and the black (K) transmission path, as shown in FIG. 16. In this manner, an image with higher image quality can be formed in substantially the same transmission time as the conventional data transmission time, as in the first embodiment.

Although a few preferred embodiments of the present invention have been shown and described, it would be appreciated by those skilled in the art that changes may be made in these embodiments without departing from the principles and spirit of the invention, the scope of which is defined in the claims and their equivalents. For example, in each of the above embodiments, data transmission is performed between the system control unit 4 that controls the entire image forming apparatus and the engine control unit 7 that controls the printer engine that is the writing unit. However, the present invention may be applied to data transmission between an image reading device such as the scanner 20 and the system control unit 4, between the PC 21 and the system control unit 4, and between the system control unit 4 and an external controller.

As is apparent from the above description, in accordance with the present invention, the transmission path(s) allocated for color(s) that is not used in image formation as well as the transmission path allocated for the designated color (s) is used in a case where an image is to be formed only with the designated color(s) among several colors. Also, the format of the image data of the designated color(s) is converted to improve the image quality, and the image data are then transmitted through the transmission path(s) allocated for color(s) that are not used in the image formation as well as the transmission path(s) allocated for the designated color(s). Although the amount of image data is increased by the improvement in image quality, a transmission delay is not caused, as the image data are transmitted through two or more transmission paths. Thus, a high-quality image can be formed without a delay.

Further, all the transmission paths used in the above embodiments are originally provided in the apparatus. Accordingly, a cost increase due to the use of an extended transmission path is not caused. In the present invention, the processing speed of the image forming apparatus is increased while the image quality is improved, without an increase in data transmission frequency as in the prior art. Further, the number of transmission paths for data transmission can be increased by using the existing transmission paths. Thus, the processing capacity of the image forming apparatus can be increased without a decrease in reliability.

This patent application is based on Japanese Priority Patent Application No. 2003-170014, filed on Jun. 13, 2003, the entire contents of which, including the specification, claims, drawings, and abstract, are hereby incorporated by reference.

What is claimed is:

1. An image forming apparatus that forms a multi-color image by combining images of different colors, comprising:
an image data output unit that outputs image data of each of the different colors through transmission paths allocated for the respective different colors; and
a control unit that outputs color images to form the multi-color image to the image data output unit, and notifies the image data output unit which transmission path is to be used to transmit the image data of each of the different colors,
when only a designated color among the different colors is used to form an image, the control unit converting the format of the image data of the designated color and outputting the converted image data to the image data output unit, and
in accordance with a setting by the control unit, the image data output unit outputting the converted image data of the designated color through the transmission path allocated for the designated color and the transmission path allocated for a color that is not used to form the image.

2. The image forming apparatus as claimed in claim 1, wherein the control unit sets the transmission path physically closest to the transmission path for the designated color as another transmission path to be used to transmit the image data of the designated color.

3. The image forming apparatus as claimed in claim 1, wherein the control unit uses the same control signals to transmit the image data of the designated color through the transmission path for the designated color and to transmit the image data of the designated color through the transmission path for the color that is not used to form the image.

4. The image forming apparatus as claimed in claim 1, further comprising
an input unit that inputs an instruction from outside,
wherein, when a high-speed image forming mode is set by the input unit, the control unit does not convert the format of the image data of the designated color.

5. An image forming apparatus that forms a multi-color image by combining images of different colors, comprising:
an image data output unit that outputs image data of each of the different colors through transmission paths allocated for the respective different colors; and
a control unit that outputs color images to form the multi-color image to the image data output unit, and notifies the image data output unit which transmission path is to be used to transmit the image data of each of the different colors,
the image data output unit outputting image data of a color having a converted format through the transmission path allocated for the color and a transmission path allocated for a color that is not used.

6. The image forming apparatus as claimed in claim 5, wherein the control unit sets the transmission path physically closest to the transmission path allocated for the designated color as another transmission path to be used to transmit the image data of the designated color.

7. The image forming apparatus as claimed in claim 5, wherein the image data output unit divides the image data of the designated color according to pixel locations in a main scanning direction of the image data of the designated color, and outputs the divided color image data to the transmission path allocated for the designated color and the transmission path allocated for the color that is not used to form the image.

8. The image forming apparatus as claimed in claim 5, wherein the control unit uses the same control signals to transmit the image data of the designated color through the transmission path allocated for the designated color and to transmit the image data of the designated color through the transmission path allocated for the color that is not used to form the image.

9. The image forming apparatus as claimed in claim 5, wherein the control unit measures the amount of the image data of the designated color, and according to the measurement result, determines whether only the transmission path allocated for the designated color is used or the transmission path allocated for the designated color and the transmission path for the color not to be used to form the image are used.

10. An image data transmission method that uses transmission paths at least either to transmit image data within an image forming apparatus or to transmit image data between the image forming apparatus and an external device, the transmission paths being provided for different colors to form an image,
the method comprising the steps of:
when an image is formed only with a designated color among the different colors, converting the format of image data of the designated color; and
transmitting the converted image data of the designated color through the transmission path allocated for the designated color and a transmission path allocated for a color that is not used to form the image.

11. The image data transmission method as claimed in claim 10, wherein the image data of the designated color are transmitted through the transmission path allocated for the designated color and the transmission path physically closest to the transmission path allocated for the designated color.

12. The image data transmission method as claimed in claim 10, wherein control signals that are used to transmit the image data of the designated color through the transmission path allocated for the designated color are also used to transmit the image data of the designated color through the transmission path allocated for the color that is not used to form the image.

13. The image transmission method as claimed in claim 10, wherein, when a high-speed image forming mode is set by an input from outside, the format of the image data of the designated color is not converted.

14. An image data transmission method that uses transmission paths at least either to transmit image data within an image forming apparatus or to transmit image data between the image forming apparatus and an external device, the transmission paths being provided for different colors to form an image,
the method comprising the step of
when an image is formed only with a designated color among the different colors, transmitting the image data of the designated color through the transmission path allocated for the designated color and a transmission path allocated for a color that is not used to form the image.

15. The image data transmission method as claimed in claim 14, wherein the image data of the designated color are transmitted through the transmission path allocated for the designated color and the transmission path physically closest to the transmission path allocated for the designated color.

16. The image data transmission method as claimed in claim 14, further comprising the step of
dividing the image data of the designated color according to the pixel locations in a main scanning direction thereof, the divided image data of the designated color being transmitted through the transmission path allocated for the designated color and the transmission path allocated for the color that is not used to form the image.

17. The image data transmission method as claimed in claim 14, wherein control signals that are used to transmit the image data of the designated color through the transmission path allocated for the designated color are also used to transmission the image data of the designated color through the transmission path allocated for the color that is not used to form the image.

18. The image data transmission method as claimed in claim 14, further comprising the step of
determining whether only the transmission path allocated for the designated color is used or the transmission path allocated for the designated color and the transmission path allocated for the color that is not used to form the image are used, depending on the amount of image data of the designated color.
